(19) United States
(12) Patent Application Publication
(10) Pub. No.: US 2017/0001506 A1
(43) Pub. Date: Jan. 5, 2017

(54) COVER FOR CARGO IN TRANSIT AND DEVICE FOR SECURING A COVER TO CARGO

(71) Applicant: Commercial Sewing, Inc., Torrington, CT (US)

(72) Inventors: David Mazzarelli, Torrington, CT (US); Brian Delisle, Barkhamsted, CT (US)

(21) Appl. No.: 15/200,152

(22) Filed: Jul. 1, 2016

Related U.S. Application Data
(60) Provisional application No. 62/187,886, filed on Jul. 2, 2015.

(51) Int. Cl. B60J 11/04; B63B 17/02

(52) U.S. Cl. CPC B60J 11/04; B63B 17/02

(57) ABSTRACT

A device for covering an objected which is transported in an air stream is provided including a cover which at least partially traverses the object. An exhaust aperture is formed in the cover. A pressure differential device is disposed on the cover adjacent the exhaust aperture. The pressure differential device is configured to create a pressure differential between air under the cover and air passing over or around the cover. The pressure differential device is movable between a plurality of positions relative to the cover.

### CROSS REFERENCE TO RELATED APPLICATIONS

This application claims the benefit of U.S. provisional patent application Ser. No. 62/187,886 filed Jul. 2, 2015, the entire contents of which are incorporated herein by reference.

### BACKGROUND

The present invent generally relates to covers for protecting cargo being transported by motor vehicles and, more particularly, to a protective cover having features for securing the cover to the cargo by differential pressure.

Covers are widely employed during transit to protect valuable cargo, such as boats and other personal watercraft, snowmobiles, automobiles, bicycles, etc., from the elements of weather and from wind blown debris. However, at higher speeds, air flow has a tendency to blow the cover off of the cargo. As a result, tie down devices such as straps and buckles have been employed to secure the cover over the cargo. However, even when tied down, such cover has a tendency to whip and buffet as a result of the air flow about the cover particularly when a high speed air stream flows under the cover. This whipping and buffeting can cause the cover to tear and even damage the cargo underneath it. Moreover, the whipping and buffeting of the cover generates considerable noise and can produce undesired drag with respect to forward movement.

Accordingly, a cover for protecting cargo in transit is desired which provides simple and effective securing of the cover to the cargo.

### SUMMARY

In one embodiment, a device for covering an objected which is transported in an air stream is provided including a cover which at least partially traverses the object. An exhaust aperture is formed in the cover. A pressure differential device is disposed on the cover adjacent the exhaust aperture. The pressure differential device is configured to create a pressure differential between air under the cover and air passing over or around the cover. The pressure differential device is movable between a plurality of positions relative to the cover.

In another embodiment, a method for transporting an object on a vehicle travelling in an airstream is provided including providing an object to be transported by a vehicle, and securing a cover to the object. The cover includes at least one exhaust aperture and at least one pressure differential device disposed adjacent the at least one exhaust aperture. A position of the at least one pressure differential device is adjusted to a position generally perpendicular to a plane of a ground. The covered object is transported on the vehicle at a speed that creates an airflow over the cover and the at least one pressure differential device. A negative air pressure is created at the at least one pressure differential device to cause air to exhaust from an interior of the cover.

### BRIEF DESCRIPTION OF THE DRAWINGS

The foregoing and other features and advantages of embodiments are apparent from the following detailed description, taken in conjunction with the accompanying drawings, in which:

FIGS. 1a and 1b are side perspective views of a cover secured about a watercraft on a trailer according to an embodiment;

FIG. 2 is side perspective view of a cover secured about another watercraft according to an embodiment;

FIG. 3 is a top view of a pressure differential device of a cover according to an embodiment;

FIGS. 4a-4c are various views of a vent of the pressure differential ice of FIG. 3 according to an embodiment;

FIG. 5 is a top view of the various components of the pressure differential device of FIG. 3 according to an embodiment;

FIG. 6 is a bottom view of a support member of the pressure differential device according to an embodiment;

FIG. 7 is a cross-sectional view of a vent of the pressure differential device according to an embodiment.

The detailed description describes exemplary embodiments, together with some of the advantages and features thereof, by way of example with reference to the drawings.

### DETAILED DESCRIPTION

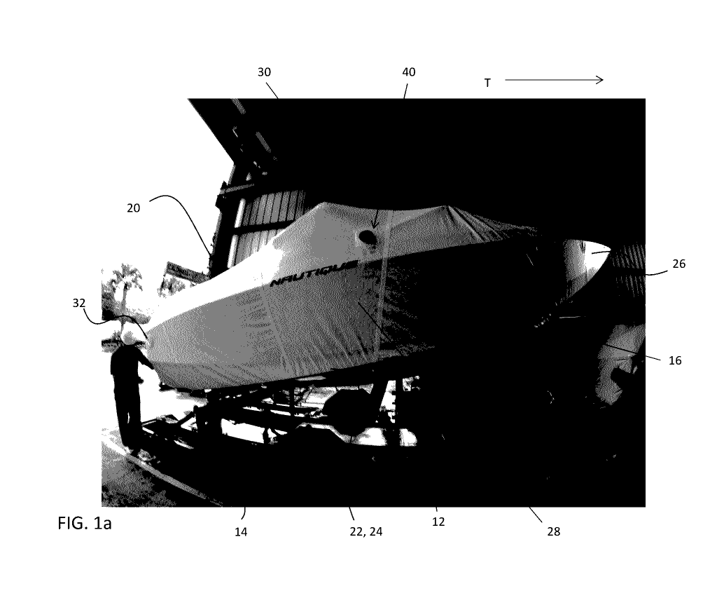

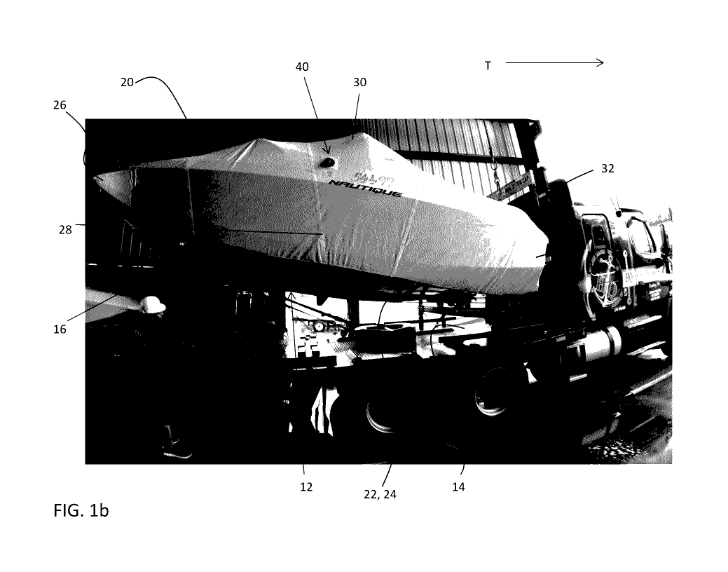

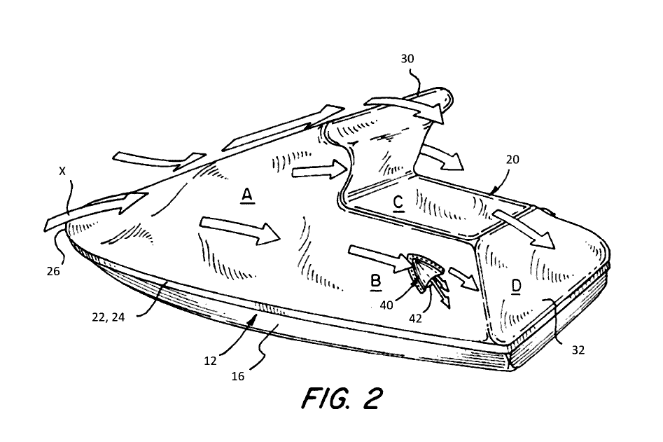

With reference now to FIGS. 1-2, an example of a cover 20 for a watercraft 12 is illustrated. As shown, the watercraft 12 is supported by and transported on a trailer transporter or other hauling device 14, by a vehicle (not shown) moving in a direction of travel indicated by the arrow T. Although the watercraft 12, as mounted on the trailer 14 in FIGS. 1a and 1b has an angled configuration relative to the ground, other configurations, such as where the watercraft 12 is parallel to the ground are within the scope of the disclosure. Application of the cover 20 to a watercraft 12 as illustrated and described herein is intended as an example only. It should be understood that the protective cover 20 may be applied to any cargo in transit, including, but not limited to, boats and other person watercrafts, snowmobiles, automobiles, bicycles, motorcycles, and/or other items in tow by a motor vehicle, train, etc., or otherwise externally exposed during transit.

The cover 20 is made of a flexible, air impermeable material which is dimensioned and configured to conform closely to one or more exterior contours of the watercraft 12. A bottom 22 of the cover 20 defines an opening (not shown) configured to fit over a hull 16 of the watercraft 12. The bottom 22 of the cover 20 is fitted to and secured about the periphery of the hull 16 by a securing feature 24, such as an elasticized band about the bottom edge 22 for example. Although the cover 20 illustrated in the FIGS. cover a substantial portion of the boat hull 16, any types of cover, such as a cover 20 configured to protect a smaller portion of the hull 16 for example, are also within the scope of the invention.

The cover 20 has a front end 26 which is disposed forwardly in relation to the direction of travel T. The cover 20 further includes sides 28, a top 30, and a rear end 32 disposed opposite the front end 26. As the watercraft 12 of FIG. 1 is transported on the trailer 14 in a generally forwards or backwards direction, air flows over and around the cover 20, in a direction indicated by arrow X, opposite the direction of travel T from the front end 26 to the rear end 32.

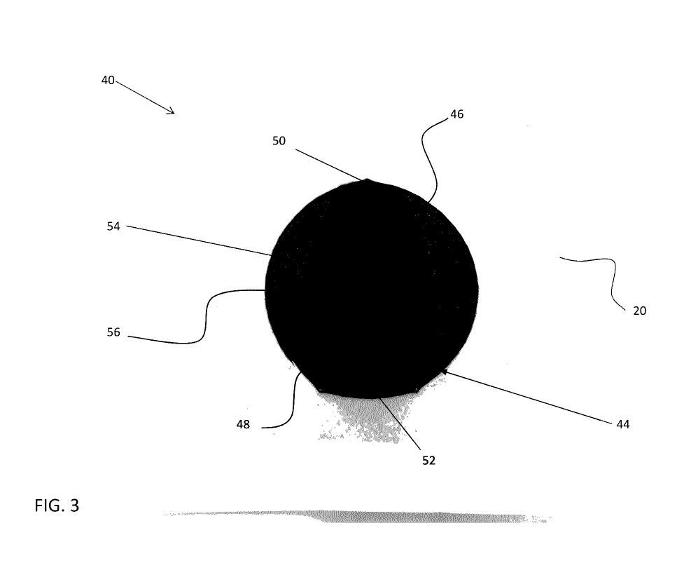

The cover 20 additionally includes at least one pressure differential device, generally designated by the numeral 40. As best seen in FIG. 3, each device 40 is disposed over an exhaust aperture 42 formed in the cover 20. With reference again to FIGS. 1 and 2, the device 40 and exhaust aperture 42 are illustrated as being disposed on a side of the cover 20. In one embodiment, a plurality of pressure different devices 40, for example two devices 40 and two corresponding exhaust apertures 42, are formed in areas of the cover 20 of smooth air flow, designated by letters A and B, such as at least one of a side 28 and a top 30 of the cover 20 for example. Alternatively, at least one pressure differential device 40 may be positioned in a less effective location, such as designated by letters C and D, in areas of turbulent air flow. In one embodiment, an equal number of exhaust apertures 42 and corresponding pressure differential devices 40 are located on both sides of the cover 20.

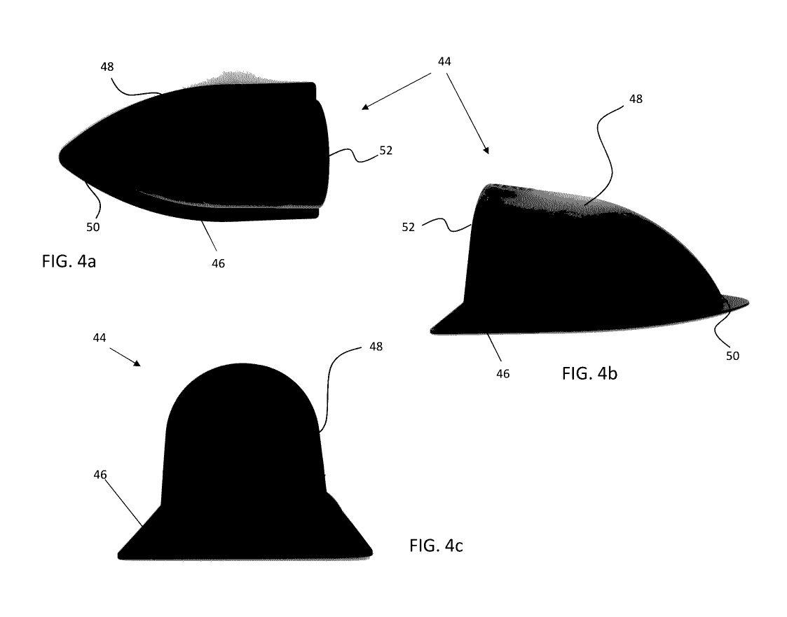

Referring now to FIGS. 3-7, the pressure differential device 40 is illustrate din more detail. The pressure differential device 40 includes a vent 44 having a base portion 46 in the form of an outwardly extending flange and a body portion 48 of arcuate cross-section which extends outwardly from the base portion 44. In one embodiment, the vent 44 has an elongated stream-lined configuration which approximates an axial segment of a cone. Therefore, the shape of the base portion 46 depends on how the cone is sliced and is either generally parabolic, hyperbolic, or “V” shaped. The body portion 48 generally includes a closed end 50 and an open end 52 configured to provide a passage 51 from the exhaust aperture 42 to the open end 52.

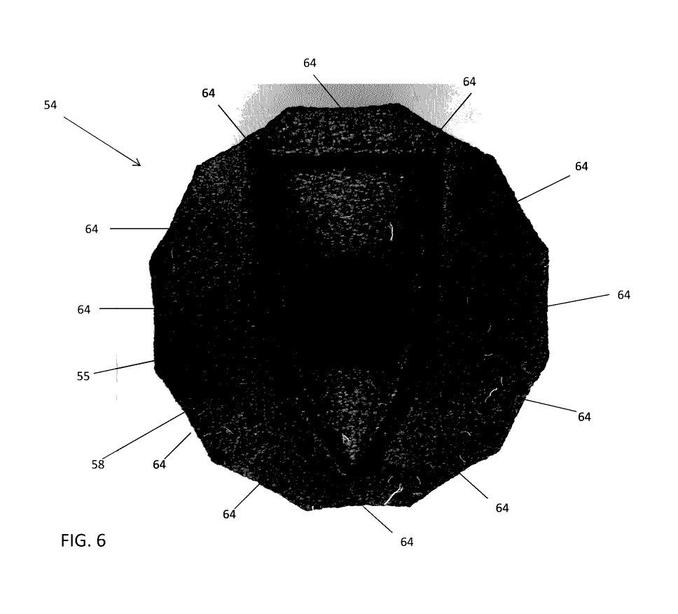

The base portion 46 of the vent 44 is affixed at a center of a first surface 56 of a foam-like support member 54. As shown in FIG. 6, the base portion 46 of the vent 44 may be sewn to the support member 54 to restrict movement of the vent 44 relative to the support member 54. However, other suitable means for connecting the vent 44 to the support member 54 including adhesives, heat sealing, and fasteners such as rivets and staples for example, are also within the scope of the disclosure. A hole 55 extending through the support member 54 is configured to fluidly couple the passage 51 within the vent 44 to the exhaust aperture 42 formed in the cover 20.

The pressure differential device 40 additionally includes a layer of fastening material 60 used to mount the vent 44 and support member 54 about an exhaust aperture 42 formed in the cover 20. The layer of fastening material 60 includes a large opening 62 such that when the layer of fastening material 60 is positioned over the support member 54 and the vent 44, the vent 44 is at least partially exposed through the opening 62. In one embodiment, a diameter of the opening 62 is substantially equal to a length of the body portion 48 of the vent 44.

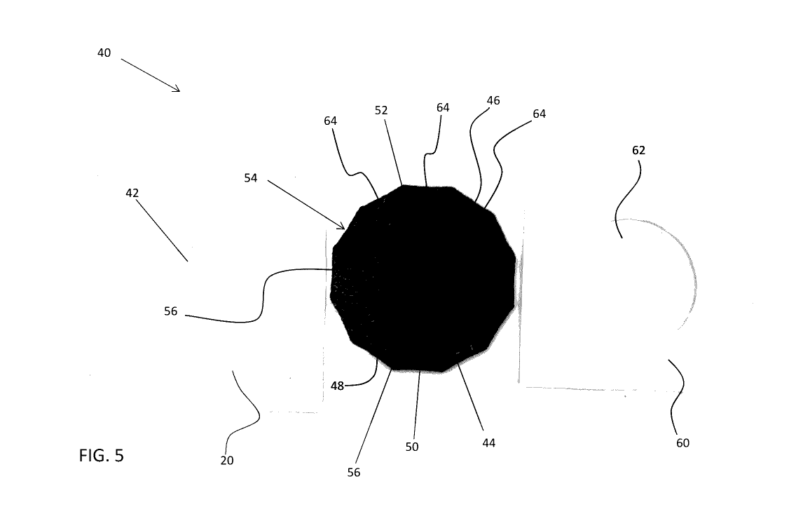

With the support member 54 arranged in an overlapping configuration with the exhaust aperture 42, the layer of fastening material 60 may be connected, such as by sewing a perimeter thereof, to the exterior of the cover 20. In one embodiment, the layer of fastening material 60 is generally rectangular in shape and has a length and width substantially equal to, or just slightly larger than, the dimensions of the support member 54. As best shown in FIGS. 5 and 6, the support member 54 has a generally polygonal shape including a plurality of substantially identical sides 64. In the illustrated, non-limiting embodiment, the support member 54 is a dodecagon having twelve substantially identical sides 64. However, a polygon having any number of identical sides 64 is within the scope of the disclosure.

The support member 54, and therefore the vent 44 mounted thereto, is configured to rotate relative to the cover 20. As a result of the minimal clearance between the connection 64 coupling the layer of fastening material 60 to the cover 20 and an adjacent side 64 of the support member 54, unintended rotation of the support member 54 is prevented. However, when a person applies a rotational force to the vent 44, the side 64 of the support member 54 in contact with the connection 64 partially deflects and the layer of fastening material 60 partially stretches to allow the support member 54 to turn incrementally such that a directly adjacent side 64 is then in contact with the connection 64. Therefore each of the plurality of sides 64 of the support member 54 provides a distinct angular position of the vent 44 relative to the cover 20. As a result, a support member 54 having a greater number of sides 64 provides greater flexibility in selecting an angular position of the vent 44.

When the watercraft 12 is being transported, it is desirable to orient the at least one pressure differential device 40 generally perpendicular to the airstream. In most embodiments, when the pressure differential device 40 is arranged perpendicular to the pressure differential device is arranged vertically, perpendicular to a plane of the ground. Because the position of the watercraft 12 when installed on a trailer 14 may not be parallel to the ground, the rotatability of the pressure differential device 40 allows the position of the vent 44 to be adjusted to a generally vertical position. In embodiments where the cover 20 includes a plurality of pressure differential devices 40, the plurality of vents 44 may be in the same position, or different positions depending on the configuration of the watercraft 12 on the trailer 14.

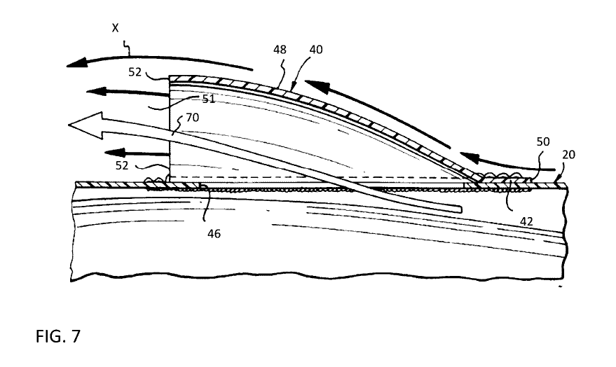

During transport, a smooth stream of air passes over the pressure differential device 40 and the streamlined shape of the vent 44 creates a negative air pressure in the area of the open end 52. This negative air pressure induces air to exhaust from under the cover 20 through the exhaust aperture 42 and up through the open end 52 of the vent 44 (as illustrated by the unshaded arrow 70 in FIG. 7), causing the cover 20 to conform closely to the surface of the watercraft 12, thereby significantly inhibiting buffeting.

With conventional covers, forces which cause buffeting thereof increase with vehicle speed. For a cover 20 including one or more pressure differential devices 40 disclosed herein, however, the negative air pressure within the cover 20 which inhibits buffeting also increases with vehicle speed and counteracts the increasing buffeting forces in the area of turbulent flow to keep the cover 20 tightly conforming to the peripheral surface of the watercraft 12. As will be understood by a person having ordinary skill in the art, the vent 44 may have alternate configurations, including generally cylindrical and spherical configurations to permit relatively smooth air flow there over to similarly create negative pressure and induce air to exhaust from the exhaust aperture.

As will be appreciated, any material may be employed for the construction of the cover 20. In one embodiment, the cover 20 is made of an air impermeable material which is flexible over a wide temperature range to accommodate for the various operating environments in which the cover may be used. Exemplary materials include synthetic resins such as 600 denier polyester or 1200 denier polypropylene, with a polyurethane resin coating. Particularly, the cover 20 may comprise a non-woven polypropylene laminated to a polyethylene sheeting. Another material which may be used is nylon or polyester film on a non-woven synthetic scrim.

Similarly, various materials may be employed for the construction of the device 40. Desirably, the device 40 will be lightweight and exhibit resiliency over a broad temperature range. Conveniently, the vent 44 of the device may be molded from of a synthetic resin such as polypropylene or other similar material.

It will be appreciated that the operation of the present invention is most effective with covers 20 which conform reasonably closely to the contours of the cargo about which they are placed, but this is not essential. It is necessary that the bottom of the cover 20 fit closely about the periphery of the cargo to minimize air flow thereunder into the interior of the cover 20. Thus, covers 20 with bottom portions which can be drawn tightly about the cargo are desirable and this can be provided by elasticized edge portions, draw strings, hook and loop fasteners, and ratcheting with flat webbing for example.

Thus, it can be seen from the foregoing detailed description and accompanying drawings that the novel protective cover of the present invention is one which effectively fits relatively closely about articles being transported and effectively prevents whipping and buffeting of the cover at transport speeds by use of a unique pressure differential device positionable on the cover in virtually any location thereon and in any orientation with respect to the direction of transport which creates a pressure-differential-induced suction of the cover to the cargo when the cargo is transported in any direction and/or pitch with respect to the direction of movement. The cover may be readily and economically fabricated for a large variety of cargos such as boats and other personal watercraft, snowmobiles, automobiles, bicycles, motorcycles, and/or other items in tow or otherwise externally exposed during transit.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A device for covering an object which is transported in an air stream, comprising:
a cover which at least partially traverses the object;
an exhaust aperture formed in the cover; and
a pressure differential device disposed on the cover adjacent the exhaust aperture, the pressure differential device being configured to create a pressure differential between air under the cover and air passing over or around the cover, the pressure differential device being movable between a plurality of positions relative to the cover.

2. The device according to claim 1, wherein the pressure differential device does not rotate relative to the cover when the covered object is being transported

3. The device according to claim 1, wherein the pressure differential causes air under the cover to exhaust to an exterior of the cover, drawing the cover toward the object.

4. The device according to claim 1, wherein the pressure differential device creates the pressure differential when the covered object is transported in one of a frontward position and a rearward position with respect to a direction of transport.

5. The device according to claim 1, wherein the pressure differential device further comprises:
a support member having an opening formed therein;
a vent having a base portion secured to said support member, and a body portion extending outwardly therefrom; and
a layer of fastening material arranged in an overlapping configuration with said support member and said vent, said layer of fastening material being attached to said cover and including an opening through which at least a portion of said vent extends.

6. The device according to claim 5, wherein said support member is polygonal in shape and includes a plurality of substantially identical sides.

7. The device according to claim 6, wherein each of said plurality of sides of said support member is configured to provide a distinct position of said pressure differential device.

8. The device according to claim 7, wherein said layer of fastening material is generally identical in size to said support member and a connection between said layer of fastening material and said cover is directly adjacent at least one of said plurality of sides of said support member.

9. The device according to claim 8, wherein interference between said connection and at least one of said plurality of sides of said support member restricts movement of said pressure differential device when said object is being transported.

10. The device according to claim 8, wherein application of a rotational force to said vent by a user causes at least one of said support member to flex and said layer of fastening material to stretch such that another side of said plurality of sides is rotated to a position directly adjacent said connection.

11. The device according to claim 5, wherein said body portion includes a closed end and an open end, said opening being configured to fluidly couple said body portion to said exhaust aperture.

12. The device according claim 11, wherein negative air pressure is created at said open end by said air passing over or around said vent, and air is exhausted from an interior of said cover to cause said cover to seat snugly about a surface of the object.

13. The device according to claim 11, wherein said body portion is arranged perpendicular to said air passing over or around said cover regardless of an orientation of said object

14. The device according to claim 5, where said body portion of said vent has an arcuate cross-section.

15. The device according to claim 5, wherein a configuration said body portion of said vent approximates an axial segment of a cone.

16. The device according to claim 5, wherein said base portion includes an outwardly extending flange.

17. The device according to claim 5, wherein said base portion is sewn to said support member.

18. A method for transporting an object on a vehicle travelling in an airstream, comprising:
providing the object to be transported by the vehicle;
securing a cover to said object, said cover including:
at least one exhaust aperture; and
at least one pressure differential device disposed adjacent said at least one exhaust aperture;
adjusting a position of said at least one pressure differential device to a position perpendicular to an airflow;
transporting the vehicle with said covered object;
creating said airflow over said cover and said at least one pressure differential device via said transporting; and
creating negative air pressure at said at least one pressure differential device to cause air to exhaust from an interior of said cover.

19. The method according to claim 18, wherein a position of said at least one pressure differential device does not change while said covered object is being transported.

20. The method according to claim 18, wherein said at least one pressure differential device further comprises:
a support member having a plurality of sides and an opening formed therein;
a vent having a base portion secured to said support member, and a body portion extending outwardly therefrom; and
a layer of fastening material arranged in an overlapping configuration with said support member and said vent, said layer of fastening material being attached at a connection to said cover, said layer of fastening material ding an opening through which at least a portion of said vent extends.

21. The method according to claim 20, wherein a position of said at least one pressure differential device is adjusted by applying a rotational force to said vent, application of said rotational force causes at least one of said support member to flex and said layer of fastening material to stretch such that another side of said plurality of sides is rotated to a position directly adjacent said connection.

22. The method according to claim 18, wherein said cover includes a plurality of pressure differential devices, and a position of each of the plurality of pressure differential device is adjusted to substantially vertical to a plane of the ground.
